(19) United States
(12) Patent Application Publication
(10) Pub. No.: US 2008/0317947 A1
(43) Pub. Date: Dec. 25, 2008

(54) Method for making a carbon nanotube-based electrical connection

(75) Inventor: Jean-Christophe Coiffic, Grenoble (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 12/213,275

(22) Filed: Jun. 17, 2008

(30) Foreign Application Priority Data
Jun. 22, 2007 (FR) 07 04464

(51) Int. Cl. B05D 5/12

(52) U.S. Cl. 427/118; 427/117

(57) ABSTRACT

At least one via comprising a bottom and side walls is formed in a layer of insulating material separating two layers of metallic material. A catalyst layer is then deposited. Then an inhibiting layer is formed by directional deposition on the walls of the via and on the insulating material layer, leaving only the part of the catalyst layer that is located in the bottom of the via free. Nanotubes are then formed in said via and electrically connect the two layers of metallic material.

### BACKGROUND OF THE INVENTION

The invention relates to a method for making an electrical connection between two layers of metallic material separated by a layer of insulating material, a method comprising:
formation in the insulating material layer of at least one via comprising a bottom and side walls,
deposition of a catalyst layer,
growth of the nanotubes in said via, the nanotubes electrically connecting the two layers of metallic material.

### STATE OF THE ART

Carbon nanotubes are currently the subject of large research efforts as their monoatomic cylindrical structure gives them exceptional properties on the nanometric scale. A promising application consists in using nanotubes in interconnects, in particular in the microelectronics industry, as described by Nihei et al. (“Electrical Properties of Carbon Nanotube Bundles for Future Via Interconnects” Japanese Journal of Applied Physics Vol. 44 N° 4A, 2005 pp 1626-1628). These interconnects are formed by two conducting metal lines, currently made of copper, situated above one another thus forming two metallic levels connected by conducting bridges called vias.

To withstand the stresses imposed by the reduction of size added to complexification of the integration parameters, it is envisaged to use carbon nanotubes as nanometric metal wires for the interconnects. The latter do in fact possess very interesting intrinsic properties compared with copper.

However, a large problem remains linked to the location of the catalyst necessary for formation of the nanotubes, only on the metallic zones of the bottom metallic interconnection level. In the above-mentioned article by Nihei et al., the catalyst is deposited after formation of the vias. The catalyst, a layer of cobalt, is deposited in the bottom of the vias by the lift-off technique and evaporation by an electron beam. This approach imposes managing to remove the catalyst and the anti-diffusion barrier on the top part of the structure to avoid parasitic growths of carbon nanotubes and short-circuits between the interconnection levels. The above-mentioned article does however remain very vague as to the integration methods on an industrial level.

The use of ionic etching has been described by Duesberg et al. in the article “Growth of Isolated Carbon Nanotubes with Lithographically Defined Diameter and Location” (Nanoletters 2003, vol. 3, n° 2, pp 257-259). However this approach gives rise to numerous problems in particular its difficulty to be integrated in an industrial process.

The document US-A-2003/0179559 describes fabrication of a simple structure in which a catalyst (Fe, Ni, Y, Co, Pt) is deposited in the bottom of the vias, without however explaining how the catalyst is selectively deposited or left at the bottom of the via. This approach does not enable nanotubes to be integrated in a double damascene structure, a particularly advantageous structure in which the hole of the via and of the following metal layer are achieved directly in the insulating layer. This technique enables advanced technological node interconnect structures to be produced while at the same time avoiding the fastidious photolithography steps.

This document also describes fabrication of carbon nanotubes in a structure enabling integration with the double damascene technique. In this case, deposition of the catalyst is performed before formation of the vias. In this way, the insulating material above the first metal level is patterned such as to define the zones where the catalyst and therefore the nanotubes are sought for. This integration does in fact enable a double damascene structure to be produced, but does nevertheless presents numerous drawbacks due to integration of the catalyst before formation of the vias. This approach then becomes particularly difficult to integrate in an industrial use with a high interconnection density.

### OBJECT OF THE INVENTION

The object of the invention is to provide a fabrication process that is easy to implement while at the same time being compatible with integration in a double damascene type structure.

The method according to the invention is characterized in that, between deposition of the catalyst and growth of the nanotubes, it comprises directional deposition of an inhibiting layer on the side walls of the via and on the insulating material layer, leaving only the part of the catalyst layer that is arranged in the bottom of the via free.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 to 4 represent the main fabrication steps of an interconnect structure according to the invention, schematically in cross-section,

FIGS. 5 to 7 represent three alternative embodiments of an interconnect structure according to the invention, schematically in cross-section.

### DESCRIPTION OF PREFERRED EMBODIMENTS OF THE INVENTION

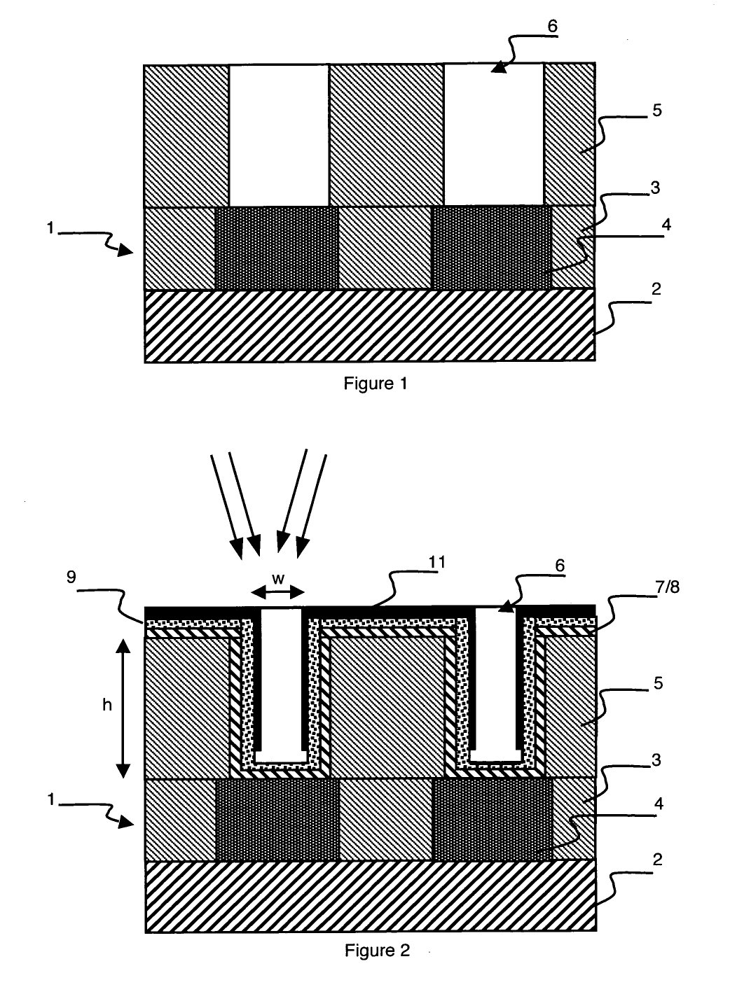

As illustrated in FIG. 1, a first metallic level 1 is made on a support 2. Support 2 is for example formed by a silicon substrate and can comprise a plurality of layers. First metallic level 1 is achieved in conventional manner and comprises an alternation between a first insulating material 3 and a first metallic material 4. First metallic material 4 thus forms patterns in first insulating material 3 over the whole height thereof. First metallic material 4 is for example made from Cu, Al, W, Ag, Pt, Pd, Ti, TiN, Ta, TaN, Mo or an alloy thereof. First insulating material 3 is preferably a low-k material, for example silicon oxide. The thicknesses of layers 3 and 4 are typically those used in a conventional metallic interconnect structure.

A layer 5 of insulating material is then deposited on first metallic level 1. This insulating material layer 5 is then patterned by any suitable technique, for example by photolithography and etching, so as to form at least one via 6 and thereby leave access to certain patterns in first metallic material 4. In a first embodiment, patterning of insulating material layer 5 enables creation of holes or vias 6 in the form of recesses having substantially vertical side walls that are straight over the whole height of insulating material layer 5.

After patterning of insulating material layer 5, the bottom of vias 6 is then materialized by zones of first metallic material 4 of first metallic level 1. The shape of vias 6 is conventionally square or round, but may also present various shapes.

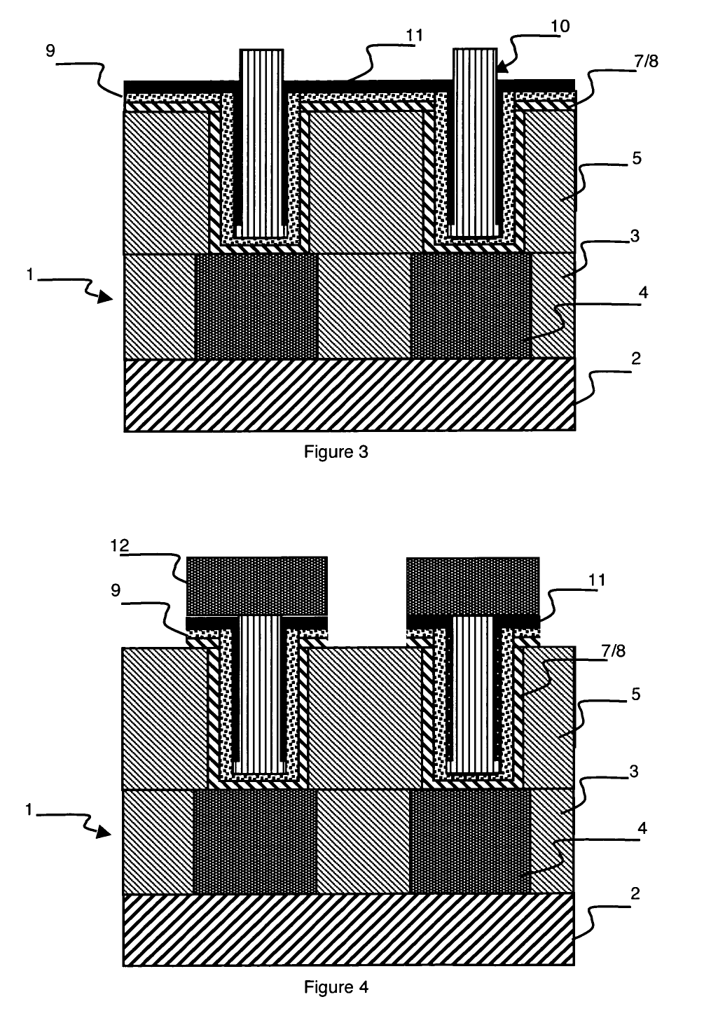

As illustrated in FIG. 2, an adhesion layer 7 and/or a barrier layer 8 is then advantageously deposited on the whole of the structure. Adhesion layer 7 strengthens the adhesion of barrier layer 8 on layer 4. Adhesion layer 7 is for example made from Ta, TaN, TiN, Ti, Al, Ru, Mn, Mo, Cr, and its thickness is advantageously less than 10 nm and may go down to deposition of an atomic layer. Barrier layer 8, generally used to prevent interdiffusion of a catalyst 9 with first metallic material 4, is for example made from Al, Al₂O₃, TiN, Ti, Ta, TaN, Mn, Ru, or Mo. Barrier layer 8 can also be self-positioned by electroless deposition, i.e. it only deposits on the zones made of first metallic material 4. Barrier layer 8 is then for example made from CoWP, CoWB, CoWP/B, NiMoP, NiMoB or any metal and alloys thereof. Barrier layer 8 can also be formed by a multilayer. Adhesion layer 7 and barrier layer 8 are deposited by any suitable technique, for example by evaporation, or sputtering under a neutral gas plasma, for example argon, helium or hydrogen. Advantageously, if first metallic material 4 is made from copper, a Tantalum (Ta) adhesion layer 7 and a barrier layer 8 able to be made from TaN, TiN or Ru will be used.

A layer of catalyst 9 designed to enable growth of nanotubes 10 is then deposited on the structure. Catalyst 9 is for example Co, Ni, Fe, Al, Al₂O₃. A stabilizing element such as Mo, Y, MgO, Mn, or Pt can be added to the catalyst. The catalyst can also be self-positioned and is then made for example from CoWP, CoWP/B, NiMoB, their oxides or their alloys. In certain cases, catalyst 9 and barrier layer 8 are one and the same and are for example made from CoWP, CoWP/B, NiMoB.

Catalyst 9 can also be deposited in the form of clusters or in the form of a multilayer of different materials. The catalyst is for example deposited by evaporation, sputtering of a material target to be deposited, cathode sputtering, or electroless deposition.

An inhibiting layer 11 is then deposited on the structure. This inhibiting layer enables catalyst 9 to be deactivated in the zones where nanotubes 10 are not desired. Inhibiting layer 11 is deposited by oblique directional deposition, as schematized by the arrows of FIG. 2, so as to cover catalyst 9 except in the bottom of vias 6. In this way, the catalyst is only left free in the bottom of vias 6 whereas inhibiting layer 11 covers the rest of the structure.

Inhibiting layer 11 can be made of conducting material, for example made from Al, Au, Pd, Ag, Ru, Cr, Ti, Cu, Pt, C, W, TiN, Mo, Si or alloys thereof, but it can also be made of insulating material, for example made from Al₂O₃, MgO, SiO₂ SixNx, SiOC, or TiO₂. Inhibiting layer 11 preferably has a thickness comprised between 3 and 500 nm, the thickness being adjusted according to the application involved. An inhibiting layer 11 of less than 3 nm is in fact generally discontinuous, all the more so for non-flat architectures. In interconnections of microelectronics type, vias 6 do not exceed 250 nm in width, the thicknesses of deposited inhibiting layer 11 being adjusted to avoid blocking the via. If transistors are integrated under layer 4, gold is not used as an inhibiting layer because gold degrades transistors performances.

Deposition of inhibiting layer 11 is performed by any technique able to achieve directed deposition or incident deposition. Deposition of layer 11 is for example performed by evaporation or sputtering techniques, for example Physical Vapor Deposition (PVD), Self Induced Plasma (SIP), or Focused Ion Beam (FIB) deposition. The evaporation technique is preferably chosen for deposition of inhibiting layer 11. Several successive depositions with different angles (between the material flux and the axis of the support) and/or different deposition conditions can be used. The angles are chosen such that inhibiting layer 11 is not deposited on the part of catalyst layer 9 located at the bottom of via 6. The geometry of the vias may make it necessary to use successive incident depositions with different angles. A means for palliating the waste of time due to the multiple depositions is using a rotating substrate having vias 6 around the material feed axis.

The optimum deposition angle [symbol] is defined with respect to the size of via 6. Angle [symbol] is defined with respect to the axis of via 6 and is given by the formula [symbol] =arc tan(w/h) where w represents the length or the diameter of via 6 and h the height of layer 5. In this way, by performing incident depositions with a larger angle than optimum angle [symbol] the inhibiting layer does not deposit in the bottom of vias 6.

As illustrated in FIG. 3, growth of nanotubes 10, which are preferably made of carbon, is then performed. Growth of nanotubes 10 is achieved in conventional manner from catalyst 9 deposited on first metallic material 4 at the bottom of vias 6. Growth of nanotubes 10 can be performed by any suitable technique, for example by chemical vapor deposition (CVD), plasma enhanced chemical vapor deposition (PECVD), Electron Cyclotron Resonance (ECR), chemical vapor deposition with hot filament, laser enhanced chemical vapor deposition, etc. Preferably, a technique enabling growth of carbon nanotubes 10 from a catalyst and at a temperature of less than 900° C. is used. The gases used in formation of carbon nanotubes can be CO, C₂H₂, CH₄, Fe(C₅H₅)₂, xylene, metallocenes, alcohols in gaseous state and all carbonaceous gases, H₂, NH₃, H₂O, O₂ or a mixture of these gases. Carbon may also be added by means of a graphite sole etched by a plasma.

Conventionally, growth of nanotubes 10 takes place from catalyst 9 arranged at the bottom of vias 6 formed in insulating material layer 5. In FIGS. 3 to 6, the nanotubes are schematized by parallel vertical lines, but while being substantially vertical, their orientation is in reality freer. Nanotubes 10 are salient upwards from vias 6.

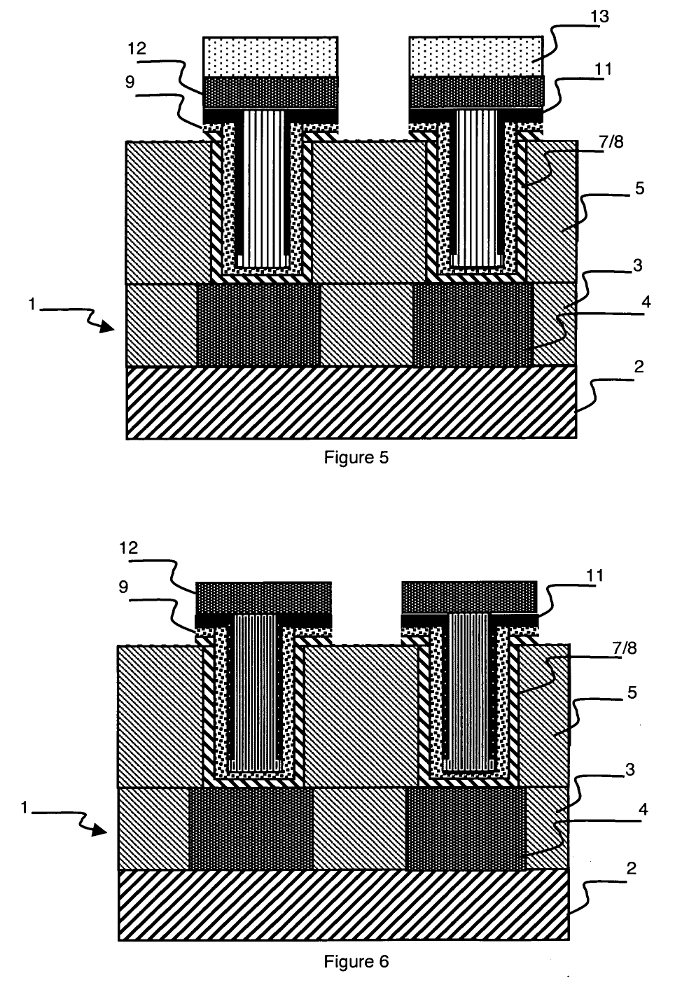

As illustrated in FIG. 4, deposition of a second metallic material 12 is then performed, and is then patterned, in conventional manner. Second metallic material 12 is for example made from Cu, Au, Al, W, Ag, Pt, Pd, Ti, TiN, Ta, TaN, Mn, Ru, Mo or one of their alloys, and its thickness is preferably comprised between 5 nm and 100 μm. With patterning of second metallic material 12, adhesion layer 7, barrier layer 8 and catalyst 9 are also eliminated. As etching of the patterns of the second metallic material stops on layer 5, there is no possible parasitic electrical contact between two adjacent vias by means of one of these layers 7, 8, 9. First metallic material layer 4 and second metallic material layer 12 are thereby electrically connected by means of nanotubes 10. In this example of embodiment, connection of the two metallic materials 4, 12 is achieved by the external walls of nanotubes 10.

The stack formed by barrier layer 8, catalyst 9 and inhibiting layer 11, which is able to be electrically conducting, is also etched at the same time as the patterns made of second metallic material 12. The patterns made of second metallic material 12 can present various shapes and orientations.

Layer of second metallic material 12 preferably has a sufficient thickness, preferably greater than 30 nm, to have a sufficient mechanical strength to enable a subsequent chemical mechanical polishing step to be performed if required. This chemical mechanical polishing step is advantageously used to trim the top ends of nanotubes 10 incorporated in metallic material layer 12 thereby allowing access to the internal walls of the nanotubes.

As illustrated in FIG. 5, deposition of a third metallic material 13 can then be performed to form a top conducting surface and to connect the internal walls of nanotubes 10. The third metallic material is for example made from Cu, Al, Au, W, Ag, Pt, Pd, Ti, TiN, Ta, or TaN. Patterning of the assembly formed by second 12 and third 13 metallic materials and by barrier layer 8, catalyst 9 and inhibiting layer 11 is performed, as before, by any suitable technique. In this alternative embodiment, the electrical contact between metallic levels 4, 12, 13 is made by simultaneously using an electrical contact by means of the external surface of nanotubes 10 and of their internal surface.

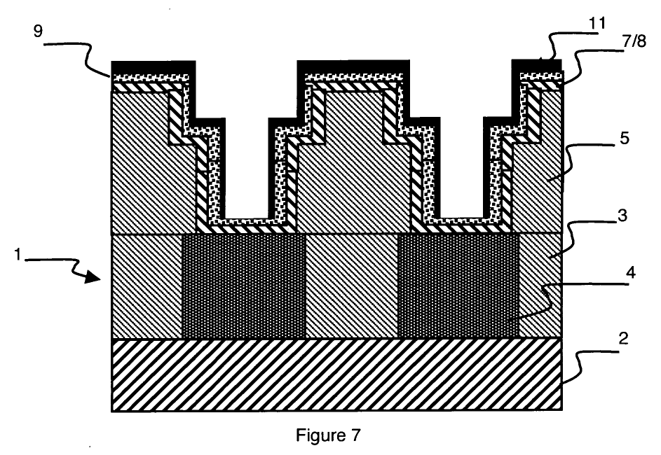

In another alternative embodiment illustrated by FIG. 6, inhibiting layer 11 being made of conducting material, it enables second metallic material 12 to be deposited by electroless means. Carbon nanotubes 10 and the bottom surface of via 6 being conducting, the latter can therefore also participate in electroless deposition but to a lesser extent. In this way, second metallic material 12 at least partially fills via 6 and also forms second metallic material layer 12 above layer 5. In this embodiment, inhibiting layer 11 is chosen such as to be very electrically conducting to facilitate implementation of electroless deposition, for example made of aluminum or gold. The material deposited by electrochemical deposition is preferably copper, but it may for example be Al, Au, Pd, Ag, Ni, Fe, Cr, Ti, Pt, C, Co, Mo, Ru, or an alloy of the latter. The material deposited by electrochemical deposition can also be a charge transfer compound, like Bechgaard's salts, such as tetra-methyl tetra selenafulvalene-based (TMTSF) salts or bisethyldithio-tetrathiafulvalene (BEDT-TTF) salts or again tetra-methyl tetrathiafulvalene (TMTTF) salts. Advantageously, when deposition completely fills the voids between the nanotubes, it enables the conductivity of the interconnect structure to be increased. Furthermore the interconnection is mechanically strengthened to be able to perform a chemical mechanical polishing step for example.

As in the previous embodiments, second metallic material layer 12 can be subjected to additional etching, for example chemical mechanical polishing or dry etching, to access the internal walls of nanotubes 10. A third metallic material 13 can thus be deposited above second metallic material 12, as in FIG. 5.

In an alternative embodiment of FIG. 2, illustrated in FIG. 7, patterning of insulating material layer 5 is performed such as to be able to use the double damascene technique. Patterning of insulating material layer 5 consists in forming a hole 6 which represents the future via but also the volume designed to be occupied by second metallic material 12. Via 6 thus comprises a shoulder and has a larger cross-section in its top part. This patterning of insulating material layer 5 is performed in conventional manner. In this alternative embodiment, directional deposition of inhibiting layer 11 is performed such that inhibiting layer also plates the enlarged section of via 6, without however obstructing the bottom of the via. This is for example achieved by a judicious choice of the sputtering angle with respect to the surface of the structure. Deposition of the catalyst is advantageously performed with a smaller incidence than the width of the via opening. The deposition thickness is moreover also adjusted to suit the dimensions of vias 6.

After growth of the nanotubes from the bottom of vias 6 and deposition of a metallic material filling at least vias 6, a conventional chemical mechanical polishing step enables the second metallic level to be located only in vias 6 of insulating material layer 5 provided for this purpose.

This approach is particularly advantageous for making interconnections presenting high interconnection densities.

This alternative embodiment can be combined with the previous embodiments to have access to the internal walls of nanotubes 10 and to fill vias 6.

1. A fabrication method of an electrical connection between two layers of metallic material separated by a layer of insulating material, a method comprising:
forming in the insulating material layer at least one via comprising a bottom and side walls,
depositing a catalyst layer,
directional depositing an inhibiting layer on the side walls of the via and on the insulating material layer, leaving only the part of the catalyst layer that is arranged in the bottom of the via free,
growing the nanotubes in said via, the nanotubes electrically connecting the two layers of metallic material.

2. The method according to claim 1, wherein a barrier layer is deposited before deposition of the catalyst.

3. The method according to claim 1, wherein an adhesion layer is deposited before deposition of the catalyst.

4. The method according to claim 1, wherein the inhibiting layer is made of conducting material chosen from Al, Au, Pd, Ru, Cr, Ti, Cu, Pt, C, W, TiN, Mo, Si or one of their alloys.

5. The method according to claim 1, wherein the inhibiting layer is made of insulating material chosen from A12O3, MgO, SiO2, SixNx, SiOC, or TiO2.

6. The method according to claim 1, wherein the inhibiting layer has a thickness comprised between 3 and 500 nm.

7. The method according to claim 1, wherein the inhibiting layer is deposited by evaporation or sputtering, PVD, SIP, or FIB.

8. The method according to claim 1, wherein after growing the nanotubes, the via is at least partially filled by the metallic material, constituting the second metallic material layer.

9. The method according to claim 8, wherein the second metallic material filling the via is deposited by electroless means.

10. The method according to claim 1, wherein the nanotubes are carbon nanotubes.

11. The method according to claim 1, wherein the via comprises a shoulder having an enlarged section in its top part.
